(19) United States
(12) Patent Application Publication
(10) Pub. No.: US 2025/0200816 A1
(43) Pub. Date: Jun. 19, 2025

(54) SUBDIVISION-IMPROVED DISPLACEMENT GENERATION

(71) Applicant: TENCENT AMERICA LLC, Palo Alto, CA (US)

(72) Inventors: Fang-Yi CHAO, Dublin (IE); Xiaozhong XU, State College, PA (US); Thuong Nguyen CANH, San Bruno, CA (US); Shan LIU, San Jose, CA (US)

(73) Assignee: TENCENT AMERICA LLC, Palo Alto, CA (US)

(21) Appl. No.: 18/937,857

(22) Filed: Nov. 5, 2024

Related U.S. Application Data
(60) Provisional application No. 63/611,085, filed on Dec. 15, 2023.

(51) Int. Cl. G06T 9/00; G06T 7/10; G06T 17/20

(52) U.S. Cl. CPC G06T 9/001; G06T 7/10; G06T 17/205

(57) ABSTRACT

A method of encoding includes receiving a polygon mesh that includes a plurality of vertices; subdividing the polygon mesh to generate a plurality sub-vertices; determining a first normal vector of a first vertex in the polygon mesh and a second normal vector of a second vertex in the polygon mesh, the first vertex and the second vertex defining an edge in the polygon mesh; moving a sub-vertex from the plurality of sub-vertices located on the edge using the first normal vector and the second normal vector; determining a displacement between the moved sub-vertex and a reference vertex from the plurality of vertices; and generating a bitstream including the displacement.

### CROSS-REFERENCE TO RELATED APPLICATION

This application claims priority from U.S. Provisional Application No. 63/611,085 filed on Dec. 15, 2023, the disclosure of which is incorporated herein by reference in its entirety.

### FIELD

This disclosure is directed to a set of advanced video coding technologies. More specifically, the present disclosure is directed to a method and apparatus for for generating the displacements in polygonal mesh codecs.

### BACKGROUND

The advances in 3D capture, modeling, and rendering have promoted the ubiquitous presence of 3D contents across several platforms and devices. Nowadays, it is possible to capture a baby's first step in one continent and allow the grandparents to see (and maybe interact) and enjoy a full immersive experience with the child in another continent. Nevertheless, in order to achieve such realism, models are becoming ever more sophisticated, and a significant amount of data is linked to the creation and consumption of those models. 3D meshes are widely used to represent such immersive contents.

A mesh is composed of several polygons that describe the surface of a volumetric object. Each polygon is defined by its vertices in 3D space and the information of how the vertices are connected, referred to as connectivity information. Optionally, vertex attributes, such as colors, normals, etc., could be associated with the mesh vertices. Attributes could also be associated with the surface of the mesh by exploiting mapping information that parameterizes the mesh with 2D attribute maps. Such mapping is usually described by a set of parametric coordinates, referred to as UV coordinates or texture coordinates, associated with the mesh vertices. 2D attribute maps are used to store high resolution attribute information such as texture, normals, displacements etc. Such information could be used for various purposes such as texture mapping and shading.

A dynamic mesh sequence may require a large amount of data since it may consist of a significant amount of information changing over time. Therefore, efficient compression technologies are required to store and transmit such contents. Mesh compression standards IC, MESHGRID, FAMC were previously developed by MPEG to address dynamic meshes with constant connectivity and time varying geometry and vertex attributes. However, these standards do not take into account time varying attribute maps and connectivity information. DCC (Digital Content Creation) tools usually generate such dynamic meshes. In counterpart, it is challenging for volumetric acquisition techniques to generate a constant connectivity dynamic mesh, especially under real time constraints. This type of contents is not supported by the existing standards. MPEG is planning to develop a new mesh compression standard to directly handle dynamic meshes with time varying connectivity information and optionally time varying attribute maps. This standard targets lossy, and lossless compression for various applications, such as real-time communications, storage, free viewpoint video, AR and VR. Functionalities such as random access and scalable/progressive coding are also considered.

### SUMMARY

According to an aspect of the disclosure, a method of encoding performed by at least one processor includes receiving a polygon mesh that includes a plurality of vertices; subdividing the polygon mesh to generate a plurality sub-vertices; determining a first normal vector of a first vertex in the polygon mesh and a second normal vector of a second vertex in the polygon mesh, the first vertex and the second vertex defining an edge in the polygon mesh; moving a sub-vertex from the plurality of sub-vertices located on the edge using the first normal vector and the second normal vector; determining a displacement between the moved sub-vertex and a reference vertex from the plurality of vertices; and generating a bitstream including the displacement.

According to an aspect of the disclosure, a method of decoding performed by at least one processor includes receiving a bitstream including a polygon mesh that includes a plurality vertices and at least one displacement; parsing the bitstream to retrieve the polygon mesh and the at least one displacement; subdividing the polygon mesh to generate a plurality sub-vertices; determining a first normal vector of a first vertex in the polygon mesh and a second normal vector of a second vertex in the polygon mesh, the first vertex and the second vertex defining an edge in the polygon mesh; moving a sub-vertex from the plurality of sub-vertices located on the edge using the first normal vector and the second normal vector; and reconstruct a reference vertex in the plurality of vertices using the moved sub-vertex and the at least one displacement.

According to an aspect of the disclosure, a method performed by at least one processor includes generating a bitstream including a polygon mesh and a displacement, wherein the polygon mesh includes a plurality of vertices, wherein the polygon mesh is subdivided to generate a plurality sub-vertices, wherein a first normal vector of a first vertex in the polygon mesh is determined and a second normal vector of a second vertex in the polygon mesh is determined, the first vertex and the second vertex defining an edge in the polygon mesh, wherein a sub-vertex from the plurality of sub-vertices located on the edge is moved using the first normal vector and the second normal vector, and wherein a displacement between the moved sub-vertex and a reference vertex from the plurality of vertices.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of a block diagram of a communication system, in accordance with embodiments of the present disclosure.

FIG. 2 is a schematic illustration of a block diagram of a streaming system, in accordance with embodiments of the present disclosure.

FIG. 3 illustrates vertex prediction using edge-based interpolation, in accordance with embodiments of the present disclosure.

FIG. 4 illustrates an example of subdivision displacement, in accordance with embodiments of the present disclosure.

FIG. 5 illustrates an flowchart of an example encoding process, in accordance with embodiments of the present disclosure.

FIG. 6 illustrates an flowchart of an example decoding process, in accordance with embodiments of the present disclosure.

FIG. 7 illustrates an example computer system diagram, in accordance with embodiments of the present disclosure.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

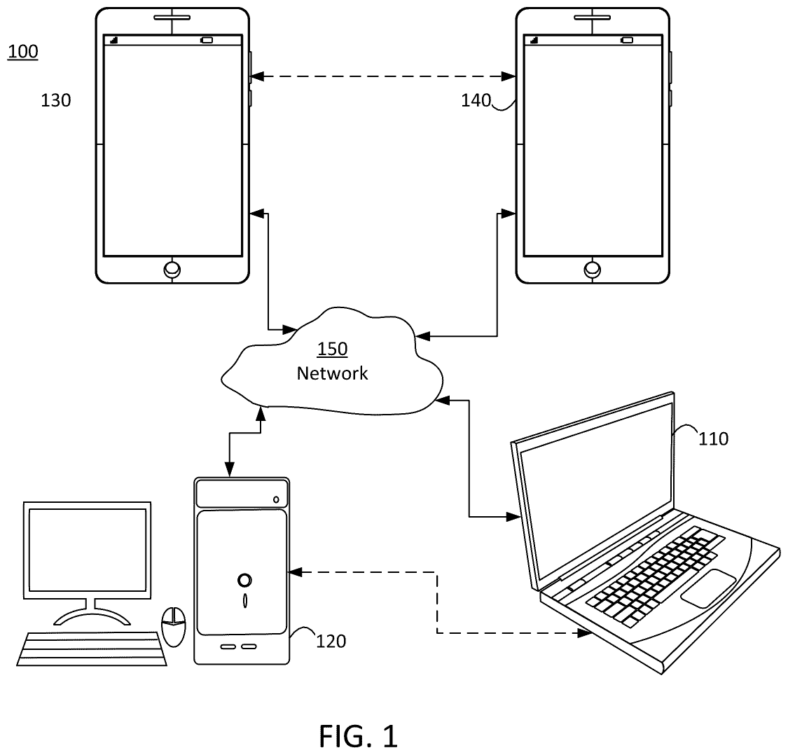

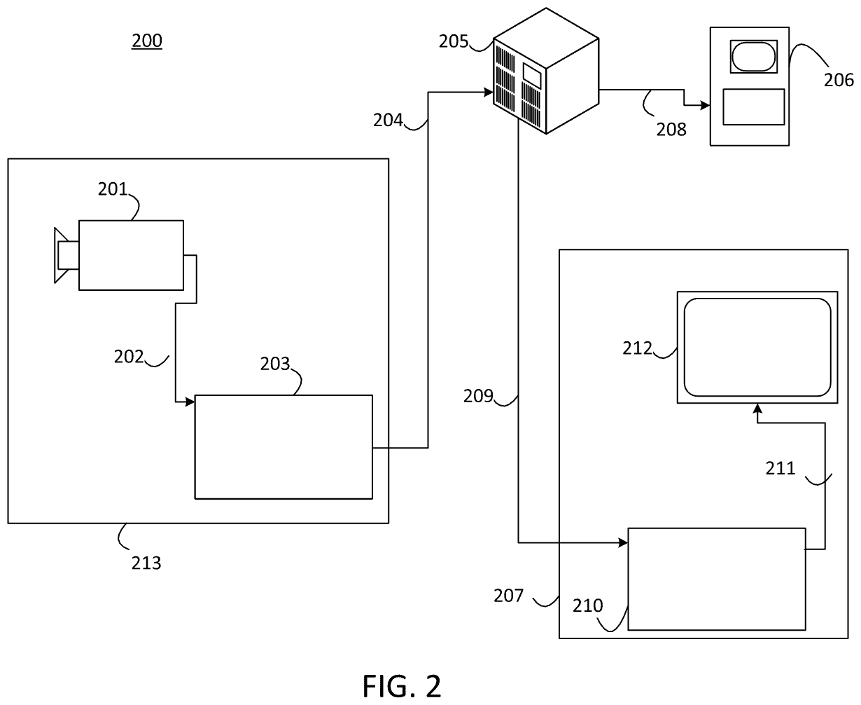

With reference to FIGS. 1-2, one or more embodiments of the present disclosure for implementing encoding and decoding structures of the present disclosure are described.

FIG. 1 illustrates a simplified block diagram of a communication system 100 according to an embodiment of the present disclosure. The system 100 may include at least two terminals 110, 120 interconnected via a network 150. For unidirectional transmission of data, a first terminal 110 may code video data, which may include mesh data, at a local location for transmission to the other terminal 120 via the network 150. The second terminal 120 may receive the coded video data of the other terminal from the network 150, decode the coded data and display the recovered video data. Unidirectional data transmission may be common in media serving applications and the like.

FIG. 1 illustrates a second pair of terminals 130, 140 provided to support bidirectional transmission of coded video that may occur, for example, during videoconferencing. For bidirectional transmission of data, each terminal 130, 140 may code video data captured at a local location for transmission to the other terminal via the network 150. Each terminal 130, 140 also may receive the coded video data transmitted by the other terminal, may decode the coded data and may display the recovered video data at a local display device.

In FIG. 1, the terminals 110-140 may be, for example, servers, personal computers, and smart phones, and/or any other type of terminals. For example, the terminals (110-140) may be laptop computers, tablet computers, media players and/or dedicated video conferencing equipment. The network 150 represents any number of networks that convey coded video data among the terminals 110-140 including, for example, wireline and/or wireless communication networks. The communication network 150 may exchange data in circuit-switched and/or packet-switched channels. Representative networks include telecommunications networks, local area networks, wide area networks, and/or the Internet. For the purposes of the present discussion, the architecture and topology of the network 150 may be immaterial to the operation of the present disclosure unless explained herein below.

FIG. 2 illustrates, as an example of an application for the disclosed subject matter, a placement of a video encoder and decoder in a streaming environment. The disclosed subject matter may be used with other video enabled applications, including, for example, video conferencing, digital TV, storing of compressed video on digital media including CD, DVD, memory stick and the like, and so on.

As illustrated in FIG. 2, a streaming system 200 may include a capture subsystem 213 that includes a video source 201 and an encoder 203. The streaming system 200 may further include at least one streaming server 205 and/or at least one streaming client 206.

The video source 201 may create, for example, a stream 202 that includes a 3D mesh and metadata associated with the 3D mesh. The video source 201 may include, for example, 3D sensors (e.g. depth sensors) or 3D imaging technology (e.g. digital camera(s)), and a computing device that is configured to generate the 3D mesh using the data received from the 3D sensors or the 3D imaging technology. The sample stream 202, which may have a high data volume when compared to encoded video bitstreams, may be processed by the encoder 203 coupled to the video source 201. The encoder 203 may include hardware, software, or a combination thereof to enable or implement aspects of the disclosed subject matter as described in more detail below. The encoder 203 may also generate an encoded video bitstream 204. The encoded video bitstream 204, which may have a lower data volume when compared to the uncompressed stream 202, may be stored on a streaming server 205 for future use. One or more streaming clients 206 and 207 may access the streaming server 205 to retrieve video bit streams 208 and 209, respectively that may be copies of the encoded video bitstream 204.

The streaming clients 207 may include a video decoder 210 and a display 212. The video decoder 210 may, for example, decode video bitstream 209, which is an incoming copy of the encoded video bitstream 204, and create an outgoing video sample stream 211 that may be rendered on the display 212 or another rendering device (not depicted). In some streaming systems, the video bitstreams 204, 208, and 209 may be encoded according to certain video coding/compression standards.

In one or more examples, to represent a mesh signal efficiently, a subset of the mesh vertices may be coded first, together with the connectivity information among them. In the original mesh, the connection among these vertices may not exist as they are subsampled from the original mesh. There are different ways to generate the connectivity information among the vertices. This subset is therefore referred to as the base mesh or base vertices.

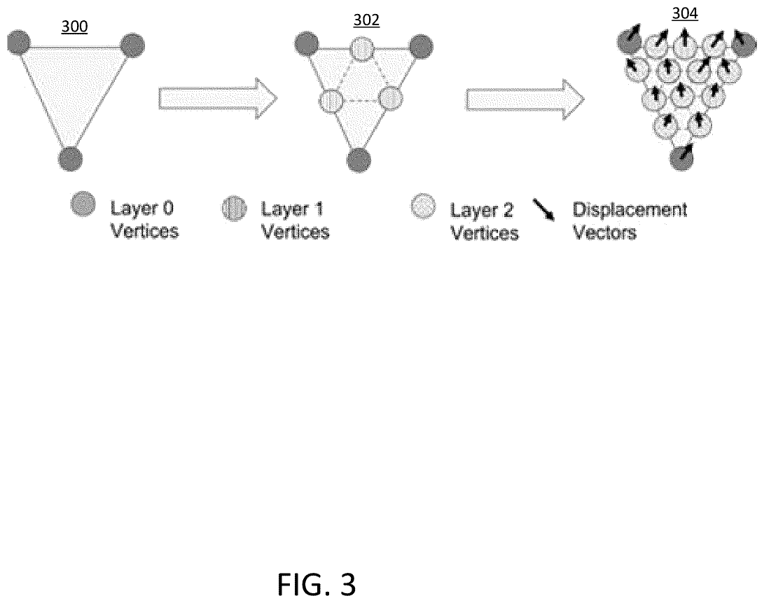

Other vertices, however, can be predicted by applying interpolation between two or more already decoded mesh vertices. A predictor vertex will have its geometry location along the edge of two connected existing vertices, so the geometry information of the predictor can be calculated based on the neighboring decoded vertices. In some cases, the displacement vector or the prediction error, from the to-be-coded vertex to the vertex predictor, is to be further coded after decoding the base vertices (e.g. the solid triangle 300 in FIG. 3). These vertices may be referred to as layer 0, where interpolation among these base vertices can be done along the connected edges. For example, the middle point of each edge can be generated as predictors. The geometry locations of these interpolated points are therefore (weighted) average of the two neighboring decoded vertices (the dashed points in FIG. 3 referring to mesh 302). Having more than 1 middle point between two already decoded vertices can also be done in a similar way. The actual vertices to be coded can therefore be reconstructed by adding the displacement vectors to the predictors (FIG. 3 Layer 1 vertices). After decoding these additional vertices, the connection among the newly decoded vertices and the existing base vertices may still maintained. In addition, connection among the newly decoded vertices can be further established. Together with the base vertices, more intermediate vertices predictors can be generated along the new edges (FIG. 3 referring to mesh 304, Layer 2 vertices) by connecting these newly decoded vertices and base vertices together. Therefore, there may be more actual vertices to be decoded with associated displacement vectors. Such an interpolation-based vertex prediction can be continued, until the total number of layers has been reached.

The displacement vectors of all layers (including those for the layer 0, or the base vertices), may be processed using various methods, such as grouping them together to perform transformation and entropy coding.

Displacements are not restricted to sub-division of a base mesh. Displacements may be produced by other mesh encoding tools, such as symmetry coding, etc. In all cases, they need to be predicted, for the improved compression. A typical approach for displacement coding is the so-called “lifting” scheme. In such as scheme, first, the reconstructed quantized base mesh is used to update the displacement field to generate an updated displacement field. This process considers the differences between the reconstructed base mesh and the original base mesh. Then a wavelet transform is applied, and a set of wavelet coefficients is generated. The wavelet coefficients are then quantized and packed into a 2D image/video or directly encoded with an arithmetic encoder.

Mesh compression can be a lossy process: the size of the bitstream, information to transmit, is reduced, at the cost of a distortion introduced in the decoded mesh. The compromise between bitrate saving and induced distortion is a typical problem in mesh compression. While the creation of displacements by coding tools allows better reconstructions of meshes at the decoder, the cost of displacement information is significant in a typical bitstream. The embodiments of the present disclosure reduce this cost while preserving the quality of the mesh.

Embodiments of the present disclosure directed to methods for subdivision-improved displacement generation for 3D mesh compression. The embodiments of the present disclosure may be applied individually or by any form of combination. The disclosed methods are not limited to mesh compression.

In one or more examples, an encoding process includes: (i) perform subdivision on base mesh; (ii) for subdivision layer 0 (e.g., base mesh), for each vertex, compute normal vectors with coded displacements; (iii) for each subdivision layer higher than 0, (a) move the subdivided vertices closer to the reference vertices on the original mesh; (b) compute the displacement between the moved subdivided vertices and the reference vertices; (c) signaling of the displacements.

In one or more examples, a decoding process includes: (i) parsing the bitstream to retrieve base mesh and the displacements; (ii) perform subdivision on base mesh; (iii) for subdivision layer 0, for each vertex, compute normal vectors with decoded displacements; (iv) for each subdivision layer higher than 0, (a) move the subdivided vertices closer to the reference vertices on the original mesh, and (b) apply the displacements to the moved subdivided vertices to reconstruct the reference vertices.

Moving the subdivided vertices closer to the reference vertices to reduce displacements and so on reduces the signaling cost for displacement. These features result in the use of fewer bits for coding displacements with an equivalent visual quality or to allocate more bits to other information to increase the visual quality. For example, using fewer bits to encode displacements allows for better subdivision (e.g., more vertices), thereby enabling finer fidelity to the original, with equivalent displacement cost.

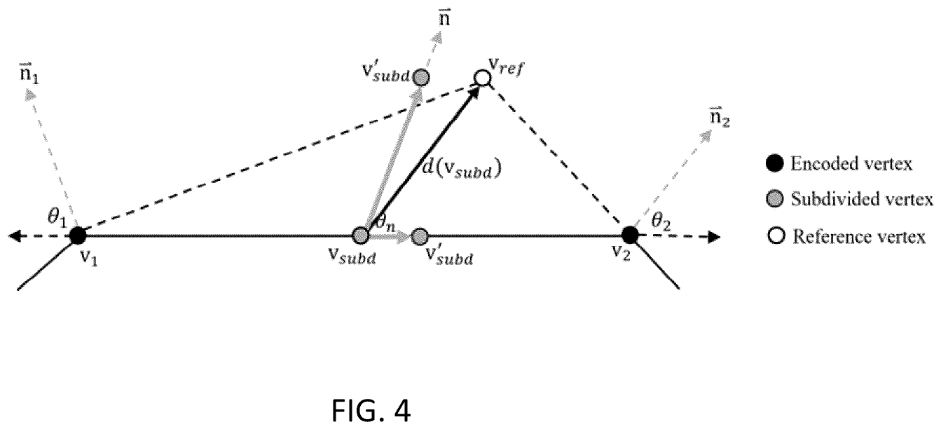

According to one or more embodiments, the direction and distance to move the subdivided vertices may be computed based on the normal vectors of the neighboring vertices. The goal is to decrease the displacement between the moved subdivided vertices and the reference vertices. FIG. 4 illustrates an example of moving a subdivided vertex close to a reference vertex to reduce the displacement.

As depicted in FIG. 4, v₁ and v₂ are the vertices in a local neighborhood on the same edge, [symbol] ₁ and [symbol] ₂ are the normal vectors of v₁ and v₂, respectively, θ₁ and θ₂ are the angles between the edge of v̅₁̅v̅₂̅ and [symbol] ₁ and [symbol] ₂, respectively, v_{subd} is the subdivided vertex between v₁ and v₂, and v_{ref} is the associate reference vertex of v_{subd}.

In one or more examples, the normal vectors [symbol] ₁ and [symbol] ₂ may be computed by using the reconstructed displacement of v₁ and v₂ as follows:

$${\vec{n}}_{1} = \vec{d} ( {v}_{1} ) / \vert \vec{d} ( {v}_{1} ) \vert , \qquad Eq . ( 1 )$$

$${\vec{n}}_{2} = \vec{d} ( {v}_{2} ) / \vert \vec{d} ( {v}_{2} ) \vert ,$$

where [symbol] (·) denotes the displacement and the operation |·| denotes the Euclidean distance (L2norm) of a vector.

In one or more examples, the normal vector [symbol] of v_{subd} may be computed by using the interpolation of [symbol] ₁ and [symbol] ₂:

$$\vec{n} = {ω}_{s u b d} * {\vec{n}}_{1} + ( 1 - {ω}_{s u b d} ) * {\vec{n}}_{2} , \qquad Eq . ( 2 )$$

where 0≤ω_{subd}≤1. In one embodiment the weight of interpolation ω_{subd}=0.5 if the mid-point subdivision is adopted. In one embodiment, the normal vector [symbol] can be computed by interpolating more neighboring vertices' normal vectors, not by interpolating [symbol] ₁ and [symbol] ₂ only.

By using the cosine of θ₁ and θ₂, the interpolation weight ω of v_{subd}′ may be computed to be close to v₁ or close to v₂.

$$ω = \frac{cos {θ}_{1}}{cos {θ}_{1} + cos {θ}_{2}} \qquad Eq . ( 3 )$$

$${v}_{s u b d}^{′} = ω * {v}_{1} + ( 1 - ω ) * {v}_{2} \qquad Eq . ( 4 )$$

By using the distance between v_{subd} and v_{subd}′, the length L along [symbol] may be estimated as:

$$L = \frac{\vert {v}_{s u b d} - {v}_{s u b d}^{′} \vert}{cos {θ}_{n}} \qquad Eq . ( 5 )$$

Then v_{subd}′ can be obtained by moving v_{subd} along [symbol] with length L as:

$${v}_{s u b d}^{′} = {v}_{s u b d} + L * \vec{n} \qquad Eq . ( 6 )$$

In one or more examples, the initial displacement [symbol] (v_{subd}) may be:

$$\vec{d} ( {v}_{s u b d} ) = {v}_{r e f} - {v}_{s u b d} \qquad Eq . ( 7 )$$

In one or more examples, the update displacement may be [symbol] (v_{subd}):

$$\vec{d} ( {v}_{s u b d}^{′} ) = {v}_{r e f} - {v}_{s u b d}^{′} \qquad Eq . ( 8 )$$

The goal is to reduce the displacement between the subdivided vertex and the reference vertex:

$$\vert \vec{d} ( {v}_{s u b d}^{′} ) \vert < \vert \vec{d} ( {v}_{s u b d} ) \vert \qquad Eq . ( 9 )$$

According to one or more embodiments, two modes can be used to decide moving the subdivided vertex v_{subd}′ along the normal vector (as equation 2) or along the edge (as equation 1). The selection criterion can be, for instance, the inner product of [symbol] ₁ and [symbol] ₂ is bigger/smaller than a threshold:

$$\{ \begin{matrix}\begin{matrix}mode 1 : move along the normal vector ( as Eq . ( 6 ) ) , \\ if {\vec{n}}_{1} * {\vec{n}}_{2} > threshold\end{matrix} \\ mode 2 : along the edge ( as Eq . ( 4 ) ) , else\end{matrix} \qquad Eq . ( 10 )$$

where the operator * denotes the inner product of 2 vectors.

According to one or more embodiments, one or more criteria may be made to turn on this procedure based on how reliable the computed normal vector [symbol] ₁ and [symbol] ₂ is. For example:
Criterion 1: the area of the face>the average area of faces;
Criterion 2: threshold₀<cos θ₁, cos θ₂<threshold₁;
Criterion 3: thresould₂<L<thresould₃.

The thresholds threshold₀, threshold₁, threshold₂, threshold₃ are designed to avoid the extremely small/big value happen.

In one or more examples, flags of enabling the procedure and/or enabling different modes are also signaled in the bitstream.

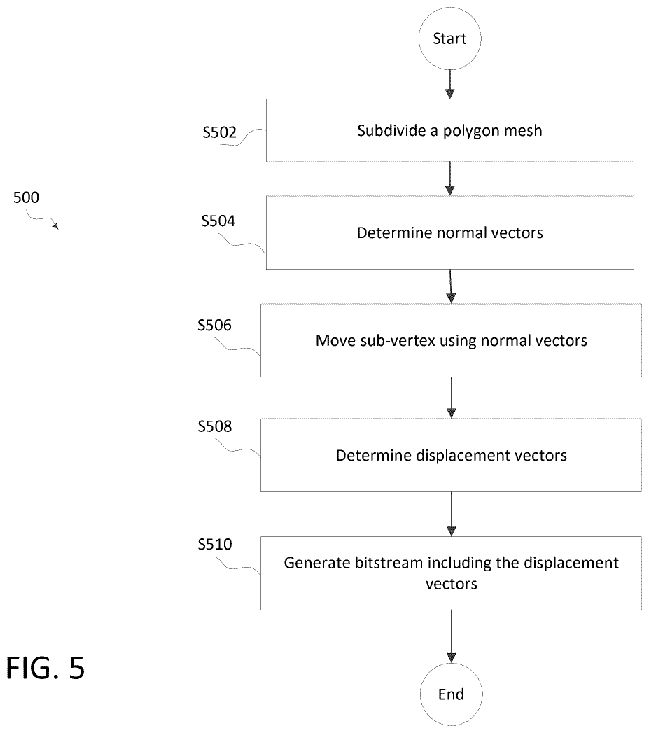

FIG. 5 illustrates an example encoding process 500, according to one or more embodiments. The encoding process 500 may be performed by encoder 203 (FIG. 2).

The process may start at operation S502 where a polygon mesh is subdivided. The polygon mesh may include a plurality of vertices, where the subdividing generates a plurality of subdivided vertices.

The process proceeds to operation S504 where normal vectors are determined for each vertex in the polygon mesh. For example, the normal vectors may be determined in accordance with Eq. (1).

The process proceeds to operation S506 where a sub-vertex is moved using the normal vectors. For example, the sub-vertex may be moved in accordance with the calculation performed in Eq. (4) or the calculation performed in Eq. (6).

The process proceeds to operation S508 where the displacement vectors are determined for the moved sub-vertex. For example the displacement vector may be determined in accordance with Eq. (8).

The process proceeds to operation S510 where a bitstream is generated including the displacement vectors. In one or more examples, operations S504-S508 may be performed for each vertex in the polygon mesh.

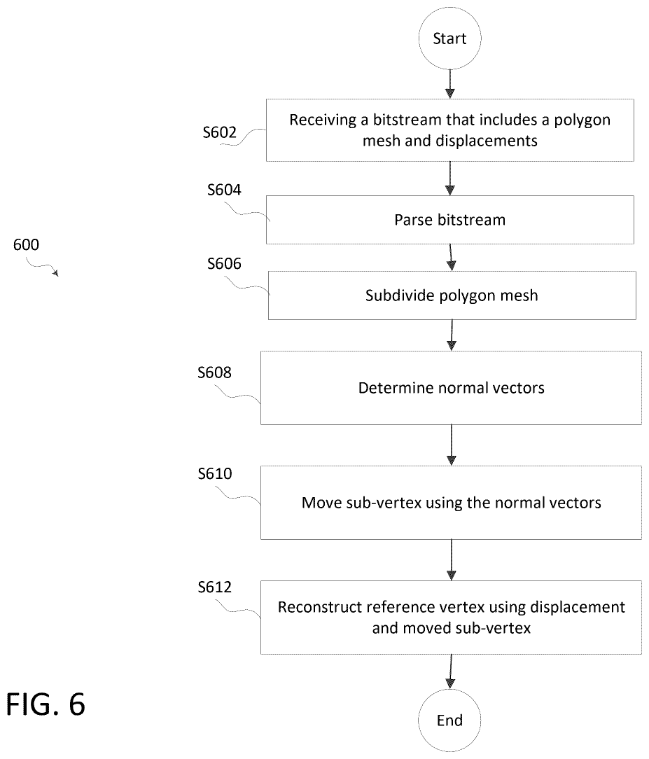

FIG. 6 illustrates an example decoding process 600, according to one or more embodiments. The process 600 may be performed by the decoder 210 (FIG. 2).

The process may start at operation S602 where a bitstream including a polygon mesh and displacements is received. The bitstream may correspond to the bitstream generated in accordance with the process illustrated in FIG. 5. The polygon mesh may include a plurality of vertices.

The process proceeds to operation S604 where the bitstream is parsed to obtain the polygon mesh and the displacements.

The process proceeds to operation S606 where the polygon mesh is subdivided to generate a plurality of subdivided vertices.

The process proceeds to operation S608 where normal vectors are determined for each vertex in the polygon mesh. For example, the normal vectors may be determined in accordance with Eq. (1).

The process proceeds to operation S610 where a sub-vertex is moved using the normal vectors. For example, the sub-vertex may be moved in accordance with the calculation performed in Eq. (4) or the calculation performed in Eq. (6).

The process proceeds to operation S612 where a reference vertex is reconstructed using the displacement and moved sub-vertex. In one or more examples, operations S608-S612 may be performed for each vertex in the polygon mesh.

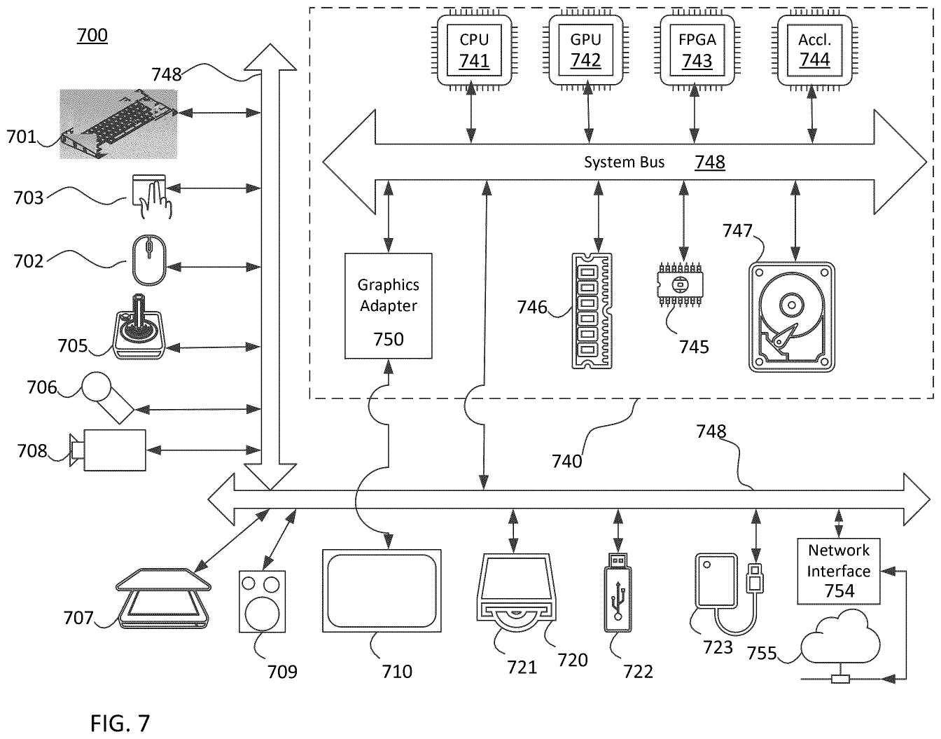

The techniques, described above, may be implemented as computer software using computer-readable instructions and physically stored in one or more computer-readable media. For example, FIG. 7 shows a computer system 700 suitable for implementing certain embodiments of the disclosure.

The computer software may be coded using any suitable machine code or computer language, that may be subject to assembly, compilation, linking, or like mechanisms to create code including instructions that may be executed directly, or through interpretation, micro-code execution, and the like, by computer central processing units (CPUs), Graphics Processing Units (GPUs), and the like.

The instructions may be executed on various types of computers or components thereof, including, for example, personal computers, tablet computers, servers, smartphones, gaming devices, internet of things devices, and the like.

The components shown in FIG. 7 for computer system 700 are examples and are not intended to suggest any limitation as to the scope of use or functionality of the computer software implementing embodiments of the present disclosure. Neither should the configuration of components be interpreted as having any dependency or requirement relating to any one or combination of components illustrated in the non-limiting embodiment of a computer system 700.

Computer system 700 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices may also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard 701, mouse 702, trackpad 703, touch screen 710, data-glove, joystick 705, microphone 706, scanner 707, camera 708.

Computer system 700 may also include certain human interface output devices. Such human interface output devices may be stimulating the senses of one or more human users through, for example, tactile output, sound, light, and smell/taste. Such human interface output devices may include tactile output devices (for example tactile feedback by the touch-screen 710, data glove, or joystick 705, but there may also be tactile feedback devices that do not serve as input devices). For example, such devices may be audio output devices (such as: speakers 709, headphones (not depicted)), visual output devices (such as screens 710 to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system 700 may also include human accessible storage devices and their associated media such as optical media including CD/DVD ROM/RW 720 with CD/DVD or the like media 721, thumb-drive 722, removable hard drive or solid state drive 723, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system 700 may also include interface to one or more communication networks. Networks may be wireless, wireline, optical. Networks may further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses 749 (such as, for example USB ports of the computer system 700; others are commonly integrated into the core of the computer system 700 by attachment to a system bus as described below (for example Ethernet interface into a PC computer system or cellular network interface into a smartphone computer system). Using any of these networks, computer system 700 may communicate with other entities. Such communication may be uni-directional, receive only (for example, broadcast TV), uni-directional send-only (for example CANbus to certain CANbus devices), or bi-directional, for example to other computer systems using local or wide area digital networks. Such communication may include communication to a cloud computing environment 755. Certain protocols and protocol stacks may be used on each of those networks and network interfaces as described above.

Aforementioned human interface devices, human-accessible storage devices, and network interfaces 754 may be attached to a core 740 of the computer system 700.

The core 740 may include one or more Central Processing Units (CPU) 741, Graphics Processing Units (GPU) 742, specialized programmable processing units in the form of Field Programmable Gate Areas (FPGA) 743, hardware accelerators for certain tasks 744, and so forth. These devices, along with Read-only memory (ROM) 745, Random-access memory 746, internal mass storage such as internal non-user accessible hard drives, SSDs, and the like 747, may be connected through a system bus 748. In some computer systems, the system bus 748 may be accessible in the form of one or more physical plugs to enable extensions by additional CPUs, GPU, and the like. The peripheral devices may be attached either directly to the core's system bus 748, or through a peripheral bus 749. Architectures for a peripheral bus include PCI, USB, and the like. A graphics adapter 750 may be included in the core 740.

CPUs 741, GPUs 742, FPGAs 743, and accelerators 744 may execute certain instructions that, in combination, may make up the aforementioned computer code. That computer code may be stored in ROM 745 or RAM 746. Transitional data may be also be stored in RAM 746, whereas permanent data may be stored for example, in the internal mass storage 747. Fast storage and retrieve to any of the memory devices may be enabled through the use of cache memory, that may be closely associated with one or more CPU 741, GPU 742, mass storage 747, ROM 745, RAM 746, and the like.

The computer readable media may have computer code thereon for performing various computer-implemented operations. The media and computer code may be those specially designed and constructed for the purposes of the present disclosure, or they may be of the kind well known and available to those having skill in the computer software arts.

As an example and not by way of limitation, the computer system having architecture 700, and specifically the core 740 may provide functionality as a result of processor(s) (including CPUs, GPUs, FPGA, accelerators, and the like) executing software embodied in one or more tangible, computer-readable media. Such computer-readable media may be media associated with user-accessible mass storage as introduced above, as well as certain storage of the core 740 that are of non-transitory nature, such as core-internal mass storage 747 or ROM 745. The software implementing various embodiments of the present disclosure may be stored in such devices and executed by core 740. A computer-readable medium may include one or more memory devices or chips, according to particular needs. The software may cause the core 740 and specifically the processors therein (including CPU, GPU, FPGA, and the like) to execute particular processes or particular parts of particular processes described herein, including defining data structures stored in RAM 746 and modifying such data structures according to the processes defined by the software. In addition or as an alternative, the computer system may provide functionality as a result of logic hardwired or otherwise embodied in a circuit (for example: accelerator 744), which may operate in place of or together with software to execute particular processes or particular parts of particular processes described herein. Reference to software may encompass logic, and vice versa, where appropriate. Reference to a computer-readable media may encompass a circuit (such as an integrated circuit (IC)) storing software for execution, a circuit embodying logic for execution, or both, where appropriate. The present disclosure encompasses any suitable combination of hardware and software.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.

(1) A method of encoding performed by at least one processor, the method including: receiving a polygon mesh that includes a plurality of vertices; subdividing the polygon mesh to generate a plurality sub-vertices; determining a first normal vector of a first vertex in the polygon mesh and a second normal vector of a second vertex in the polygon mesh, the first vertex and the second vertex defining an edge in the polygon mesh; moving a sub-vertex from the plurality of sub-vertices located on the edge using the first normal vector and the second normal vector; determining a displacement between the moved sub-vertex and a reference vertex from the plurality of vertices; and generating a bitstream including the displacement.

(2) The method according to feature (1), in which the first normal vector is determined in accordance with a first displacement vector between the reference vertex and the first vertex divided by a Euclidean distance of the first displacement vector, and in which the second normal vector is determined in accordance with a second displacement vector between the reference vertex and the second vertex divided by a Euclidean distance of the second displacement vector.

(3) The method according to feature (1) or (2), further including: determining a normal vector of the sub-vertex using a weighted sum of the first normal vector and the second normal vector.

(4) The method according to feature (3), further including: determining a weight in accordance with a cosine of a first angle divided by a sum of the cosine of the first angle and a cosine of a second angle, in which the first angle is defined by an angle between the edge and the first normal vector, and in which the second angle is defined by an angle between the edge and the second normal vector.

(5) The method according to feature (4), in which the moving sub-vertex includes: determining a first sum of the weight times the first vertex and one minus the weight times the second vertex.

(6) The method according to feature (5), in which the moving sub-vertex includes: determining a length in accordance with a difference between the sub-vertex and the first sum divided by a cosine of angle between the edge and the normal vertex of the sub-vertex.

(7) The method according to feature (6), in which the moving sub-vertex includes: determining a second sum of the sub-vertex and the length times the normal vector of the sub-vertex.

(8) The method according to feature (7), in which one of the first sum and the second sum is set as a position of the moved sub-vertex in accordance with a first predetermined condition.

(9) The method according to feature (8), in which the first predetermined condition specifies that (i) the first sum is the position of the moved sub-vertex based on determining that a product of the first normal vector and the second normal vector is less than or equal to a first threshold, and (ii) the second sum is the position of the moved sub-vertex based on determining the product of the first normal vector and the second normal vector is greater than the first threshold.

(10) The method according to feature (9), in which the bitstream includes a first flag indicating that one of the first sum and the second sum indicates the position of the moved sub-vertex.

(11) The method according to feature (10), in which a second flag in the bitstream indicates that the first flag is enabled in accordance with a second predetermined condition being satisfied.

(12) The method according to feature (11), in which the second predetermined condition is satisfied based on determining that (i) an area of a face including the edge is greater than an average of an area of faces in the polygon mesh, (ii) the cosine of the first angle and the cosine of the second angle are greater than a second threshold and less than a third threshold, or (iii) the length is greater than a fourth threshold and less than a fifth threshold.

(13) A method of decoding performed by at least one processor, the method including receiving a bitstream including a polygon mesh that includes a plurality vertices and at least one displacement; parsing the bitstream to retrieve the polygon mesh and the at least one displacement; subdividing the polygon mesh to generate a plurality sub-vertices; determining a first normal vector of a first vertex in the polygon mesh and a second normal vector of a second vertex in the polygon mesh, the first vertex and the second vertex defining an edge in the polygon mesh; moving a sub-vertex from the plurality of sub-vertices located on the edge using the first normal vector and the second normal vector; and reconstruct a reference vertex in the plurality of vertices using the moved sub-vertex and the at least one displacement.

(14) The method according to feature (13), in which the first normal vector is determined in accordance with a first displacement vector between the reference vertex and the first vertex divided by a Euclidean distance of the first displacement vector, and in which the second normal vector is determined in accordance with a second displacement vector between the reference vertex and the second vertex divided by a Euclidean distance of the second displacement vector.

(15) The method according to feature (13), further including: determining a normal vector of the sub-vertex using a weighted sum of the first normal vector and the second normal vector.

(16) The method according to feature (15), further including: determining a weight in accordance with a cosine of a first angle divided by a sum of the cosine of the first angle and a cosine of a second angle, in which the first angle is defined by an angle between the edge and the first normal vector, and in which the second angle is defined by an angle between the edge and the second normal vector.

(17) The method according to feature (16), in which the moving sub-vertex includes: determining a first sum of the weight times the first vertex and one minus the weight times the second vertex.

(18) The method according to feature (17), in which the moving sub-vertex includes: determining a length in accordance with a difference between the sub-vertex and the first sum divided by a cosine of angle between the edge and the normal vertex of the sub-vertex.

(19) The method according to feature (18), in which the moving sub-vertex includes: determining a second sum of the sub-vertex and the length times the normal vector of the sub-vertex.

(20) A method performed by at least one processor includes: generating a bitstream including a polygon mesh and a displacement, in which the polygon mesh includes a plurality of vertices, in which the polygon mesh is subdivided to generate a plurality sub-vertices, in which a first normal vector of a first vertex in the polygon mesh is determined and a second normal vector of a second vertex in the polygon mesh is determined, the first vertex and the second vertex defining an edge in the polygon mesh, in which a sub-vertex from the plurality of sub-vertices located on the edge is moved using the first normal vector and the second normal vector, and in which a displacement between the moved sub-vertex and a reference vertex from the plurality of vertices.

What is claimed is:

1. A method of encoding performed by at least one processor, the method comprising:
receiving a polygon mesh that includes a plurality of vertices;
subdividing the polygon mesh to generate a plurality sub-vertices;
determining a first normal vector of a first vertex in the polygon mesh and a second normal vector of a second vertex in the polygon mesh, the first vertex and the second vertex defining an edge in the polygon mesh;
moving a sub-vertex from the plurality of sub-vertices located on the edge using the first normal vector and the second normal vector;
determining a displacement between the moved sub-vertex and a reference vertex from the plurality of vertices; and
generating a bitstream including the displacement.

2. The method according to claim 1, wherein the first normal vector is determined in accordance with a first displacement vector between the reference vertex and the first vertex divided by a Euclidean distance of the first displacement vector, and
wherein the second normal vector is determined in accordance with a second displacement vector between the reference vertex and the second vertex divided by a Euclidean distance of the second displacement vector.

3. The method according to claim 1, further comprising:
determining a normal vector of the sub-vertex using a weighted sum of the first normal vector and the second normal vector.

4. The method according to claim 3, further comprising:
determining a weight in accordance with a cosine of a first angle divided by a sum of the cosine of the first angle and a cosine of a second angle,
wherein the first angle is defined by an angle between the edge and the first normal vector, and
wherein the second angle is defined by an angle between the edge and the second normal vector.

5. The method according to claim 4, wherein the moving sub-vertex comprises:
determining a first sum of the weight times the first vertex and one minus the weight times the second vertex.

6. The method according to claim 5, wherein the moving sub-vertex comprises:
determining a length in accordance with a difference between the sub-vertex and the first sum divided by a cosine of angle between the edge and the normal vertex of the sub-vertex.

7. The method according to claim 6, wherein the moving sub-vertex comprises:
determining a second sum of the sub-vertex and the length times the normal vector of the sub-vertex.

8. The method according to claim 7, wherein one of the first sum and the second sum is set as a position of the moved sub-vertex in accordance with a first predetermined condition.

9. The method according to claim 8, wherein the first predetermined condition specifies that (i) the first sum is the position of the moved sub-vertex based on determining that a product of the first normal vector and the second normal vector is less than or equal to a first threshold, and (ii) the second sum is the position of the moved sub-vertex based on determining the product of the first normal vector and the second normal vector is greater than the first threshold.

10. The method according to claim 9, wherein the bitstream includes a first flag indicating that one of the first sum and the second sum indicates the position of the moved sub-vertex.

11. The method according to claim 10, wherein a second flag in the bitstream indicates that the first flag is enabled in accordance with a second predetermined condition being satisfied.

12. The method according to claim 11, wherein the second predetermined condition is satisfied based on determining that (i) an area of a face including the edge is greater than an average of an area of faces in the polygon mesh, (ii) the cosine of the first angle and the cosine of the second angle are greater than a second threshold and less than a third threshold, or (iii) the length is greater than a fourth threshold and less than a fifth threshold.

13. A method of decoding performed by at least one processor, the method comprising:
receiving a bitstream including a polygon mesh that includes a plurality vertices and at least one displacement;
parsing the bitstream to retrieve the polygon mesh and the at least one displacement;
subdividing the polygon mesh to generate a plurality sub-vertices;
determining a first normal vector of a first vertex in the polygon mesh and a second normal vector of a second vertex in the polygon mesh, the first vertex and the second vertex defining an edge in the polygon mesh;
moving a sub-vertex from the plurality of sub-vertices located on the edge using the first normal vector and the second normal vector; and
reconstruct a reference vertex in the plurality of vertices using the moved sub-vertex and the at least one displacement.

14. The method according to claim 13, wherein the first normal vector is determined in accordance with a first displacement vector between the reference vertex and the first vertex divided by a Euclidean distance of the first displacement vector, and
wherein the second normal vector is determined in accordance with a second displacement vector between the reference vertex and the second vertex divided by a Euclidean distance of the second displacement vector.

15. The method according to claim 13, further comprising:
determining a normal vector of the sub-vertex using a weighted sum of the first normal vector and the second normal vector.

16. The method according to claim 15, further comprising:
determining a weight in accordance with a cosine of a first angle divided by a sum of the cosine of the first angle and a cosine of a second angle,
wherein the first angle is defined by an angle between the edge and the first normal vector, and
wherein the second angle is defined by an angle between the edge and the second normal vector.

17. The method according to claim 16, wherein the moving sub-vertex comprises:
determining a first sum of the weight times the first vertex and one minus the weight times the second vertex.

18. The method according to claim 17, wherein the moving sub-vertex comprises:
determining a length in accordance with a difference between the sub-vertex and the first sum divided by a cosine of angle between the edge and the normal vertex of the sub-vertex.

19. The method according to claim 18, wherein the moving sub-vertex comprises:
determining a second sum of the sub-vertex and the length times the normal vector of the sub-vertex.

20. A method performed by at least one processor, the method comprising:
generating a bitstream including a polygon mesh and a displacement,
wherein the polygon mesh includes a plurality of vertices,
wherein the polygon mesh is subdivided to generate a plurality sub-vertices,
wherein a first normal vector of a first vertex in the polygon mesh is determined and a second normal vector of a second vertex in the polygon mesh is determined, the first vertex and the second vertex defining an edge in the polygon mesh,
wherein a sub-vertex from the plurality of sub-vertices located on the edge is moved using the first normal vector and the second normal vector, and
wherein a displacement between the moved sub-vertex and a reference vertex from the plurality of vertices.
